(19) United States
(12) Patent Application Publication
(10) Pub. No.: US 2026/0178684 A1
(43) Pub. Date: Jun. 25, 2026

(54) SYSTEMS AND METHODS FOR IDENTIFYING REPRESENTATIVE DATA

(71) Applicant: The Bank of New York Mellon, New York, NY (US)

(72) Inventors: Filipe Joao Cabrita Condessa, Pittsburgh, PA (US); Vadim Pertsovskiy, Pittsburgh, PA (US)

(21) Appl. No.: 18/990,873

(22) Filed: Dec. 20, 2024

(51) Int. Cl. G06F 17/10

(52) U.S. Cl. CPC G06F 17/10

(57) ABSTRACT

Systems, methods, and computer-readable storage media for identifying a representative data are shown. In an aspect, the method includes receiving a set of input data. The method includes generating a representation of a set of embeddings based at least in part on the set of input data. The method includes aligning a distribution of one or more models to a reduced representation of the set of embeddings. The method includes generating a tessellation of the distribution. The method includes identifying the plurality of data points indicative of the representative data.

### TECHNICAL FIELD

The present disclosure generally relates to identifying representative data from a set of input data and more particularly to systems and methods for generating a tessellation associated with the set of input data and selecting representative data points from partitioned portions of the tessellation.

### BACKGROUND

Machine learning (ML) and natural language processing (NLP) are types of artificial intelligence (AI) technologies that are used across a variety of industries to increase efficiency, for example, by automating tasks associated with the industries, analyzing data, making predictions about the tasks, and so forth. Such AI technologies may use algorithms to analyze data and identify patterns about the data. The AI technologies may use the patterns to create a model that makes predictions, for example, via training, evaluation, and verification cycles. The training cycle may include a process where a model learns from input data (e.g. text, images, video, tables, patterns, and so forth) and adjusts internal parameters to reduce errors in future predictions. The evaluation cycle may include a process of assessing performance of the model on new or different data that the model has not seen, for example, to determine if the model has learned and may accurately apply the learned patterns to the new data. The verification cycle may ensure that the model functions as expected (e.g., reliability of model and compliance with specifications).

In some cases, the AI technologies may use in-context learning (e.g., an ML model) or multi-shot prompting (e.g., an NLP, where the model is given multiple examples in the prompt to understand task). The in-context learning and multi-shot prompting may use a representative set of examples (e.g., training and validation data) to teach a model. For example, a model may learn new tasks without having to be fine-tuned or retrained. The model may receive examples (e.g., “context”) within a prompt, and then use the examples to guide the model to perform a task without fine-tuning or retraining for the particular task. That is, the model may not need additional training on new data to perform the task and instead, may use the context of inputted examples.

In some cases, AI technologies using in-context learning or multi-shot prompting may have a finite or limited context window that limits the number of examples that may be used to prompt the model. Determining representative data that is representative of the entire set of input data to fit within the limited context window may be difficult. Moreover, arbitrary selection of the representative data from the input data may be time-consuming and/or may not be an accurate representation of the input data since the selection is subjective.

### SUMMARY

To overcome the challenges described above, aspects of the present disclosure provide systems, methods, and computer-readable storage media for identifying representative data from a set of input data (e.g., text data), such as by generating a tessellation associated with the set of input data and selecting representative data points from partitioned portions of the tessellation. In an aspect, a method for selective representative data points may include receiving a set of input data. The method may include generating a representation of a set of embeddings based on the set of input data. The method may include aligning a distribution of one or more models to a reduced representation of the set of embeddings. The method may include generating a tessellation of the distribution. The method may include identifying a set of data points from the tessellation, where the set of data points are indicative of the representative data, which includes less data or data points than the input data.

In some examples, generating the representation of the set of embeddings may involve using a multiple embedding functions. In such examples, the method may include applying a set of embedding functions (e.g., multiple independently trained embedding functions) to the set of input data, applying a dimensionality reduction to the set of embeddings, and generating the reduced representation of the set of embeddings based on applying the dimensionality reduction to the set of embeddings.

In some examples, generating the representation of the set of embeddings may involve using a single embedding function rather than multiple embedding functions. In such examples, the method may include applying a single embedding function to the set of input data, applying a low-rank projection estimation to the set of embeddings, and generating the reduced representation of the set of embeddings based on applying the low-rank projection estimation to the set of embeddings. The low-rank projection estimation may be based on a mapping function trained with a sample set of data of the set of input data.

In some examples, the method may further include partitioning the tessellation of the distribution into a set of cells. In such examples, identifying the set of data points may include selecting a centroid data point from each of the set of cells as the set of data points. Additionally, or alternatively, identifying the set of data points may include selecting the set of data points from the set of cells.

Using the aforementioned features, which are described in more detail below with reference to FIGS. 1-7, identifying representative data (e.g., key data points) from input data may facilitate in accurately providing representative data to a model for a limited context window, for example, that is associated with in-context learning model or multi-shot prompting model. Selecting key data points that are representative of the input data, may facilitate model efficiency and effectiveness of prompt-driven AI applications, as well as reduce impact on utility of constrained resources. For example, using the key data points may generate a concise output without exceeding the context limit. Processing fewer, more indicative or key data points may reduce the computational overhead for both inference and training of the model. Using key data points may also reduce inaccurate representation of the input data that may otherwise occur due to arbitrary selection of the key data points.

Moreover, the techniques described herein facilitate cost-efficient and time-efficient techniques by using a single embedding function and/or relatively less expensive embedding functions when applying the embedding functions to the input data (e.g., rather than using independently trained multiple embedding functions that are relatively more expensive). In some examples, the techniques described herein utilize a direct lower-rank approximation of the multiple embedding functions using neural networks, also providing cost-efficient and time-efficient techniques for identifying the representative data.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 is a block diagram illustrating an example system for identifying representative data from a set of input data in accordance with aspects of the present disclosure;

FIG. 2 is a flow diagram for identifying representative data from a set of input data in accordance with aspects of the present disclosure;

FIG. 3 is a flow diagram for identifying representative data from a set of input data in accordance with aspects of the present disclosure;

FIG. 4 shows example of a tessellation of the set of input data in accordance with aspects of the present disclosure;

FIG. 5 shows example of a tessellation of the set of input data in accordance with aspects of the present disclosure;

FIG. 6 shows example of a tessellation of the set of input data in accordance with aspects of the present disclosure;

FIG. 7 shows a flow diagram of an example method for identifying representative data from a set of input data in accordance with aspects of the present disclosure;

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

In some cases, the AI technologies, such as machine learning (ML) and natural language processing (NLP), may use in-context learning (e.g., an ML model) or multi-shot prompting (e.g., an NLP model), where the model is given multiple examples in the prompt to understand a task. The in-context learning and multi-shot prompting may involve using a representative set of examples (e.g., training and validation data) to teach a model. For example, a model may learn new tasks without needing to be fine-tuned or retrained. The model may receive examples (e.g., “context”) within a prompt, and then uses the examples to guide the model to perform a task without fine-tuning or retraining for the particular task. That is, the model may not need additional training on the new data to perform the task and instead, uses the context of inputted examples.

In some cases, AI technologies using in-context learning or multi-shot prompting may have a finite or limited context window that limits the number of examples that may be used to prompt the model. Determining representative data to fit the limited context window from the set of input data may be difficult. Moreover, arbitrary selection of the representative data from the input data may be time-consuming and/or may not be an accurate representation of the input data since the selection is subjective.

As discussed herein, to accurately select representative data (e.g., select key points) from the input data, a tessellation of the input data may be generated. In particular, the process of selecting key points indicating representative data may include applying multiple independently trained embedding functions to the input data and combining the output of the embedding functions (e.g., stacked embedding where multiple different embedding models are combined by stacking them on top of each other). The process may include applying a dimensionality reduction on the output for computation efficiency and to increase density of the representation The process may include fitting a distribution of one or more models to the reduced dimensionality data (e.g. Gaussian Mixture Models (GMM), K-means, or other clustering techniques). The process may include generating a tessellation of the data by partitioning the reduced dimensionality data based on K distribution. The process may include selecting key points from the tessellated data that are representative of the input data. For example, the key points may include selecting a key point from each cell, selecting based on centroids of each of the cells, or the like. The selected key points may be used to prompt the AI model for in-context learning or multi-shot prompting.

Additionally, or alternatively, to the multiple embedding functions, a single embedding function and/or relatively inexpensive one or more embedding functions may be used. The single embedding function and/or less expensive embedding functions may be more computationally efficient to use than the multiple embedding functions. Additionally, or alternatively, to applying a dimensionality reduction to the output of the combination multiple embedding functions, a low-rank estimation may be applied. For example, a mapping function may be trained to approximate the output of the multiple embedding functions when applied to the output of the single or less expensive embedding functions, which may be more computationally efficient to use than applying the dimensionality reduction to the output of the multiple embedding functions.

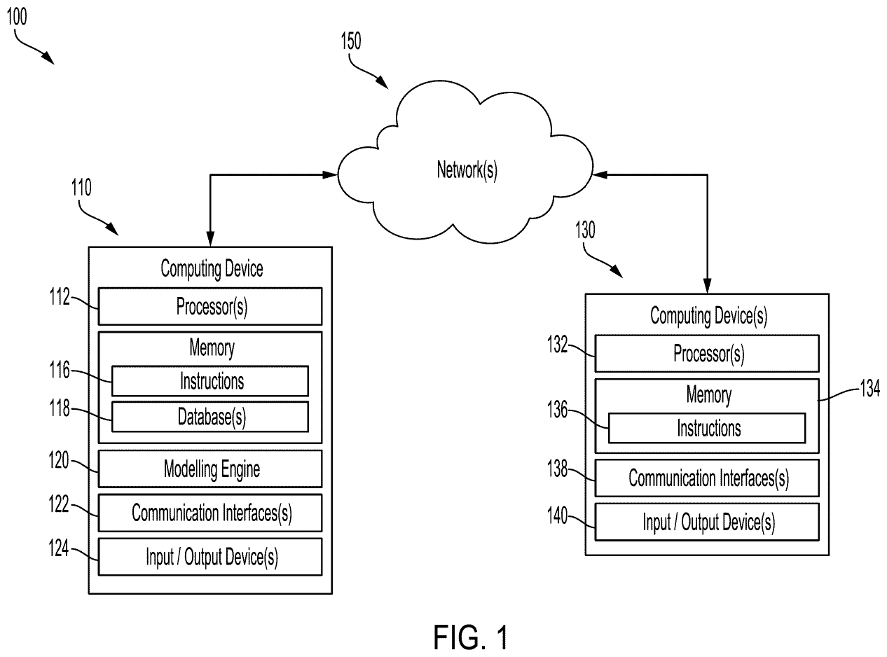

Referring to FIG. 1 a block diagram of a system operating in accordance with aspects of the present disclosure is shown as a system 100. The system 100 includes a computing device 110 configured to receive input data, such as from a computing device 130 via one or more networks 150, and to produce, as output, representative data (e.g., key data points) used as examples to train a model. The output may be a prompt, which includes examples, instructions, or context that defines what a model is supposed to do or generate. It is noted that while FIG. 1 is primarily described with reference to functionality provided by computing device 110, it should be understood that the functionality described herein may be provided in a distributed computing environment, such as using a set of computing devices 110, or a cloud-based deployment.

As illustrated in FIG. 1, the computing device 110 includes one or more processors 112, a memory 114, a modeling engine 120, one or more communication interfaces 122, and input/output (I/O) devices 124. The one or more processors 112 may include a central processing unit (CPU), graphics processing unit (GPU), a microprocessor, a controller, a microcontroller, a set of microprocessors, an application-specific integrated circuit (ASIC), an application-specific standard product (ASSP), or any combination thereof. The memory 114 may include read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. The memory 114 may also store instructions 116 that, when executed by the one or more processors 112, cause the one or more processors 112 to perform operations described herein with respect to the functionality of the computing device 110 and the system 100. The memory 114 may further include one or more databases 118, which may store data associated with operations described herein with respect to the functionality of the computing device 110 and the system 100.

The communication interface(s) 122 may be configured to communicatively couple the computing device 110 to the one or more networks 150 via wired and/or wireless communication links according to one or more communication protocols or standards. The I/O devices 124 may include one or more display devices, a keyboard, a stylus, a scanner, one or more touchscreens, a mouse, a trackpad, a camera, one or more speakers, haptic feedback devices, or other types of devices that enable a user to receive information from or provide information to the computing device 110.

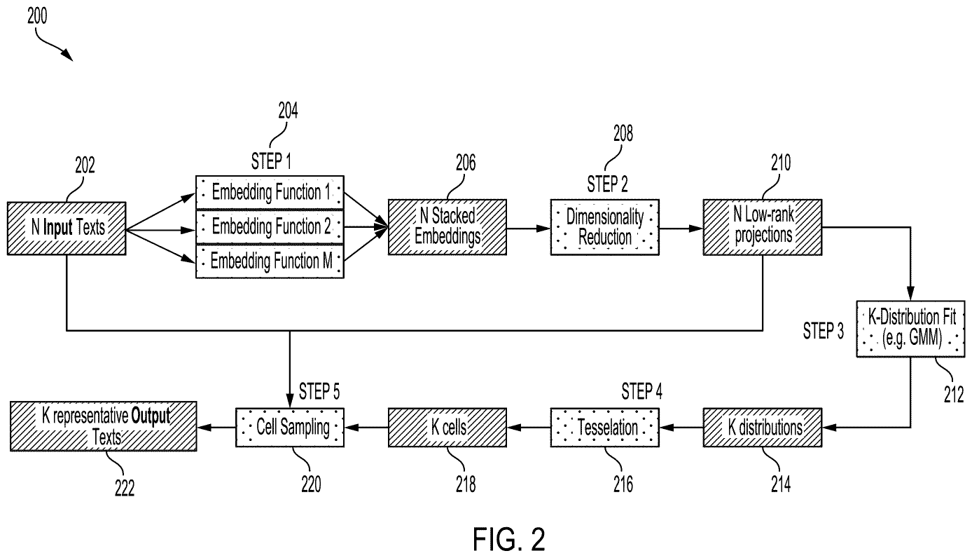

The one or more databases 118 may be configured to store information and/or documents. For example, the one or more databases 118 may include one or more databases storing input data and/or representative data that is used for training a model, and other data that may be used for in-context learning and multi-shot prompting, as discussed with respect to FIGS. 2-7. For example, the one or more databases 118 may also store K models (e.g., one or more models) used for model distributions, as well as algorithms to generate and partition a tessellation of the input data.

The computing device 130 is shown to include one or more processors 312, a memory 134 storing instructions 136, one or more communication interfaces 138, and one or more I/O devices 140. These elements of the computing device 130 may be similar to the corresponding elements of the computing device 110 described above.

The modeling engine 120 of the computing device 110 may be configured to support operations for accurately identifying the representative data from input data, as discussed in detail with respect to FIGS. 2-7. Although the following discussions describe the modeling engine 120 as performing the identification and tessellation techniques described herein, the techniques may be performed, additionally or alternatively, by the computing device 110 or any components of the computing device 110.

For example, the modeling engine 120 may be configured to receive, by one or more processors, a set of input data. The modeling engine 120 may generate, by the one or more processors, a representation of a set of embeddings based on the set of input data. The modeling engine 120 may align, by the one or more processors, a distribution of one or more models to a reduced representation of the set of embeddings. The modeling engine 120 may generate, by the one or more processors, tessellation of the distribution. The modeling engine 120 may identify, by the one or more processors, a set of data points from the tessellation, the set of data points indicative of the representative data. The representative set of input data corresponding to the set of data points may include less data than the set of input data. The set of input data may include text data.

In some examples, the modeling engine 120 may further apply, by the one or more processors, a set of embedding functions to the set of input data. The modeling engine 120 may apply, by the one or more processors, a dimensionality reduction to the set of embeddings. The modeling engine 120 may generate, by the one or more processors, the reduced representation of the set of embeddings based on applying the dimensionality reduction to the set of embeddings.

In some examples, the modeling engine 120 may apply, by the one or more processors, a single embedding function to the set of input data. The modeling engine 120 may apply, by the one or more processors, a low-rank projection estimation to the set of embeddings. The modeling engine 120 may generate, by the one or more processors, the reduced representation of the set of embeddings based on applying the low-rank projection estimation to the set of embeddings. In such examples, the low-rank projection estimation may be based on a mapping function trained with a sample set of data of the set of input data.

In some examples, the modeling engine 120 may partition, by the one or more processors, the tessellation of the distribution into a set of cells. In such examples, identifying the set of data points may include the modeling engine 120 selecting, by the one or more processors, a centroid data point from each of the set of cells as the set of data points. Additionally, or alternatively, identifying the set of data points may include the modeling engine 120 selecting, by the one or more processors, the set of data points from the set of cells (e.g., non-centroid points). In some example, the modeling engine 120 may provide, by the one or more processors, the set of data points to one or more language learning models as examples for in-context learning.

FIG. 2 is a flow diagram 200 for identifying representative data in accordance with aspects of the present disclosure. The flow diagrams described herein, including the flow diagram 200, may implement aspects of or may be implemented by aspects of the system 100. In the following descriptions of flow diagrams described herein, including the flow diagram 200, the operations performed may be performed in different orders or at different times than the example order shown. Some operations and/or components may also be omitted from the flow diagram 200, or other operations and/or components may be added to the flow diagram 200. The examples described herein are not to be construed as limiting, as the described features may be associated with any quantity of different devices. Although the techniques described herein are described with respect to a limited context window, the techniques may apply to any environment or context involving inputting reduced quantity of input examples, entries, or data. As an example, the techniques described herein may apply to financial services, healthcare, retail, manufacturing, and the like.

At step 202, the process of identifying representative data may include receiving N input texts, where N refers to two or more input text strings (e.g., 2, 20, 35, 50, 1000, 100000, and so forth). In some examples, the input data may be words, sentences, tables, and so forth. At step 204, the process includes inputting the N input texts into multiple embedding functions (e.g., step 1). The multiple embedding functions may be trained based on the N input texts (e.g., original dataset). The embedding functions may map input data, such as the text, into a dense, fixed-dimensional vector space where semantically similar inputs are close together.

In some examples, the embedding functions may be based on different NLP architectures, such as Bidirectional Encoder Representations from Transformers (BERT), Generative Pre-trained Transformer (GPT), and the like, and/or may be trained using different datasets, such as Wikipedia, books, and so forth. Such datasets may be described with respect to a context description for ML and NLP tasks, such as content structure, utility, characteristics, and so forth.

The multiple embedding functions may be fine-tuned to the original dataset. Fine-tuning adjusts the embeddings to reflect the nuances of a particular dataset or task. For example, the pre-trained embeddings functions (e.g., BERT) are trained for general-purpose inputs and fine tuning may adjust them to reflect details of the input text. In some examples, the multiple embedding functions may be jointly trained to ensure that the output of each embedding function is maximally different from the output of the other embedding functions (e.g. by minimizing cross-entropy). Such training may ensure that the embedding functions may input data (e.g., N input text) to vectors that enable accurate prediction of labels.

In some examples, at step 206, the process may include combining the output from the multiple embedding functions into N stacked embeddings. Stacked embeddings may refer to combining the multiple types of text embeddings to create a more robust representation of the input text, for example, based on various linguistic features, such as syntactic, semantic, and contextual information.

At step 208, the process may include applying a dimensionality reduction (e.g., step 2). In some examples, stacked embeddings may result in large vectors with significantly increased dimensionality (e.g., since embeddings may be combined and become concatenated), often resulting computational inefficiencies (e.g., in training and inference) and/or overfitting (e.g., models may learn noise in the data). Applying the dimensionality reduction may reduce the high-dimensional feature space created by combining multiple embedding vectors as the stacked embeddings.

In some examples, the concatenated embeddings may be reduced in dimensionality using a dimensionality reduction technique, such as Principal Component Analysis (PCA) (e.g., a linear dimensionality reduction technique), Uniform Manifold Approximation and Projection (UMAP) (e.g., a nonlinear dimensionality reduction technique), or t-Distributed Stochastic Neighbor Embedding (t-SNE) (e.g., a nonlinear dimensionality reduction technique used for visualizing high-dimensional data in 2-dimension (2D) or three-dimensional (3D)).

At step 210, the dimensionality reduction may result in N low-rank projections (e.g., reduced dimensionality dataset), where high-dimensional data is approximated or estimated by projecting it onto a subspace of lower dimensionality, characterized by a small number of basis vectors (or components). For example, a low-rank approximation may reduce the rank of a matrix, representing it with fewer independent components. The low-rank projections may represent input text in a way that retains the most important information while reducing noise and computational complexity (e.g., of the stacked embeddings).

In some examples, a subset of the multiple embeddings may be selected based on non-repeating inputs to increase the expressiveness of the dimensionality reduction (i.e. unique inputs are encoded and the dimensionality reduction disregards duplicate entries). Such dimensionality reduction may result in faster computations and ensure a more uniform distribution and density of the input data in the reduced dimensionality space.

At step 212, the process may include fitting or aligning K models (e.g., one or more models) to the reduced dimensionality dataset resulting from step 208 and step 210 (e.g., step 3). Fitting or aligning K models to the reduced dimensionality dataset involves the process of applying a probability distribution (e.g., distribution of a model) that best describes (e.g., “fits”) the dataset, for example, by identifying the parameters of a theoretical distribution that aligns most closely with the observed data. The distribution may be a GMM, a mixture of experts, or any other distribution that may capture the underlying structure of the reduced dimensionality dataset. Each of the K models may be a representation of different portions of the reduced dimensionality dataset, able to capture different aspects of the dataset.

A volume-proxy measure may be used to ensure that each model is representative of a similar volume of the dataset (e.g., number of samples or number of unique samples). As an example, the volume-proxy measure may be a result of constraining the determinant of the covariance or precision matrix (e.g., of the GMM) to be similar across each of the models. The determinant of the covariance matrix or precision matrix may be used to measure data spread and dependency.

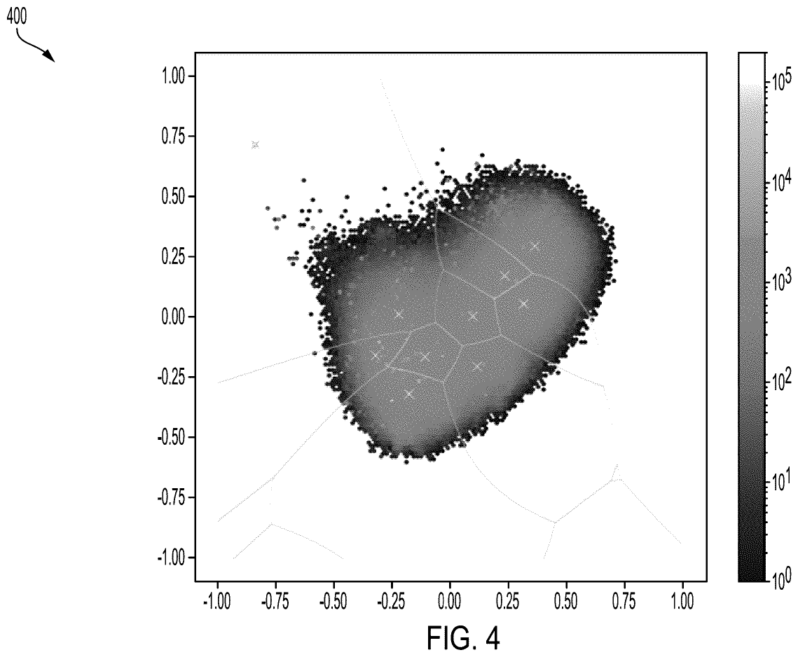

At step 214, the output of applying the K-distribution fitting at step 212 (e.g., fitting dataset to model distributions) may result in K fitted distributions. Proper evaluation and validation may ensure that the fitted distributions accurately represents the input text (e.g., input data). Accordingly, at step 216, the process may include generating a tessellation (e.g., step 4), as illustrated with respect to FIGS. 4-6, for evaluating the K fitted distributions. In particular, the tessellation may involve partitioning the reduced dimensionality dataset space (e.g., 2D or 3D space) by dividing the reduced dimensionality dataset space into non-overlapping regions, cells. The cell shapes may be polygons, cubes, or other geometric shapes depending on the method used for tessellating.

Dividing into the cells may involve (1) identifying pairs of adjacent groups or distributions based on the K models fitted to the reduced dimensionality dataset. Dividing into cells may further involve (2) defining a surface for each pair of adjacent groups that separates adjacent groups in the reduced dimensionality dataset space into two regions of equivalent volume (e.g. a hyperplane that separates the two groups in the reduced dimensionality dataset space, surface that separates two groups based on the distance of the samples to the centers of the groups, or a closed form solution to separate pairs of Gaussians on equal probability distribution levels). Step (2) of dividing into cells may result in a signed distance function. Dividing into cells may further involve (3) computing cells based on an aggregate result of the signed distance functions, and allocating data points to the corresponding cell. Accordingly, at step 218, tessellation may result in K cells, for example, based on the partitioning.

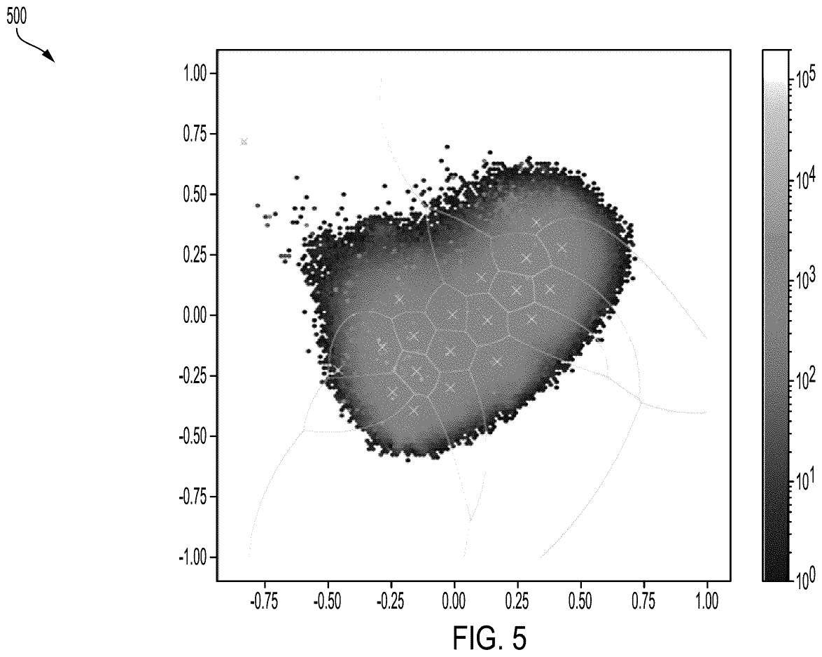

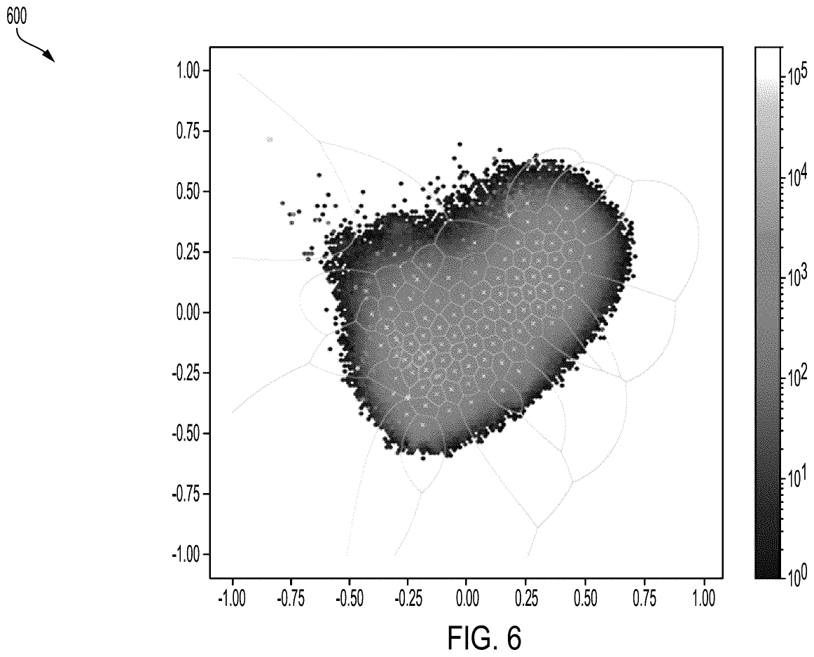

For the quantity of K cells, K may be based on the limited content window. For example, if the limited content window limits input examples to 10, then the reduced dimensionality dataset space may be portioned into 10 cells, where K=10). As an example, FIG. 4 show an example of a tessellation, where the partitioning results in 10 cells. As an example, FIG. 5 show an example of a tessellation, where the partitioning results in 20 cells. As an example, FIG. 6 show an example of a tessellation, where the partitioning results in 100 cells.

Turning back to FIG. 2, at step 220, the process may include cell sampling (e.g., step 5). Cell sampling may refer to the process of selecting data points or regions (e.g., cells) from the tessellated space in order to estimate, model, and/or analyze the data based on the structure of the tessellation. Data points may be sampled from specific cells or regions of the tessellation. In some examples, the samples or data points may be sampled from each of the cell (e.g., one data point from each of the cells). Additionally, or alternatively, the data points may be sampled based on centroids of the cells or other sampling functions. The sampling may result in the representative data of the original input texts (e.g., at step 202). Accordingly, at step 222, the cell sampling may result in K representative output texts, which are an accurate representation of the input text and include fewer texts than the original input texts. The samples of the key data points may be used as prompts (e.g., for the LLM model) and examples for in-context learning or multi-shot prompting. Accordingly, using the techniques described herein, the resulting samples may be selected to ensure that evaluation of the models is performed in a way that is representative of the entire data set.

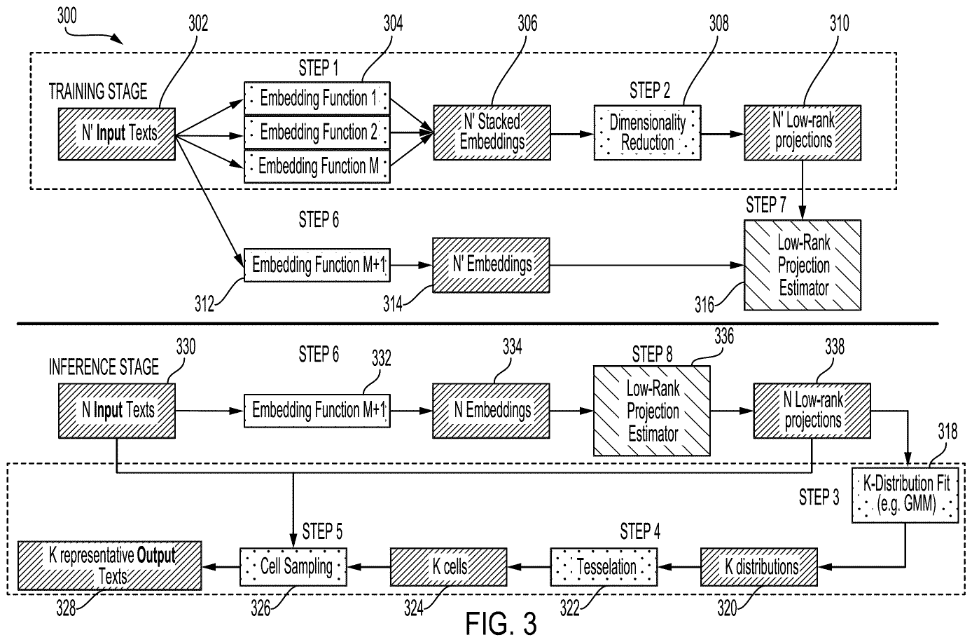

FIG. 3 is flow diagram 300 for identifying representative data from a set of input data in accordance with aspects of the present disclosure. The flow diagrams described herein, including the flow diagram 300, may implement aspects of or may be implemented by aspects of the system 100. In the following descriptions of flow diagrams described herein, including the flow diagram 300, the operations performed may be performed in different orders or at different times than the exemplary order shown. Some operations and/or components may also be omitted from the flow diagram 300, or other operations and/or components may be added to the flow diagram 300. The examples described herein are not to be construed as limiting, as the described features may be associated with any quantity of different devices.

The flow diagram 300 describes the process with respect to a training stage and an inference stage, where some of the steps may be similar in each process, as discussed herein. However, flow diagram 300 describes the process of identifying representative data from the input data using a single embedding function rather than multiple embedding functions, for computational efficiency. Also, the single embedding function may be more cost-efficient than the independently trained multiple embedding functions. During the training stage, steps 302, 304, 306, 308, and 310 may operate similarly as described with respect to FIG. 2 (as shown by the dashed line box). For example, step 302 may correspond to 202, step 304 may correspond to 204, step 306 may correspond to 206, step 308 may correspond to 208, step 310 may correspond to 210.

At step 312, a single embedding function may be applied to the N′ input data from 302 (e.g., step 6). The N′ input data may be input text. In some examples, the N′ input data may be, tables, images, and the like. The output of the embedding function may result in N′ embeddings at step 314. The N′ embeddings may be stacked, as discussed with respect to steps 306 and 206. For example, the N′ embeddings may be converted into a concatenation or stacking of the embeddings. That is, steps 312 and 314 (e.g., step 6) may correspond to step 202 and 204 of FIG. 2 but use a single, less expensive embedding function that is applied to each of the input texts on N′.

The N′ input texts may include a small set of samples (e.g., quantity of N′ input texts is less than the quantity of N input texts). Steps 312 and 314 may be performed in sequence to obtain a reduced dimensionality representation of the dataset of N′. The N′ input text may be encoded by the less expensive embedding function to obtain the representative data. At step 316 (e.g., step 7) the neural network may be trained to approximate the output of a low-rank approximation of the relatively more expensive embedding functions (e.g., of step 304) using the embeddings of the more computationally efficient and less expensive embedding function at step 312. The neural network may be trained using a small number of samples from the original dataset (e.g., N input texts of 302), and may be used to approximate the output of the multiple embedding functions (e.g., of step 304) for the entire dataset of (e.g., N input texts of 302).

During the inference stage, steps 318, 320, 322, 324, 326, and 328 may operate similarly as described with respect to FIG. 2 (as shown by the dashed line box). For example, step 318 may correspond to 212, 320 may correspond to 214, 322 may correspond to 216, 324 may correspond to 218, 326 may correspond to 220, and 328 may correspond to 222. Step 330 may correspond (e.g., operate similarly) to 302, step 332 may correspond to 312, and 334 may correspond to 314.

At step 336 (e.g., step 8) a low-rank projection estimator is applied to the output of the combined embeddings at step 334, resulting in N low-rank projections at step 338. The reduced dimensionality representation of the dataset is obtained by encoding the dataset with the less expensive embedding function (e.g., of step 312). The neural network trained at step 316 may be used to approximate the output of a low-rank approximation of the relatively more expensive multiple embedding function (e.g., from step 304) to approximate the output of the embeddings of step 332, which includes the more computationally efficient embedding function applied to each of the N input texts. Steps 332 and 336 may result in faster and cheaper approximation with respect to the combination of steps 304 and 308 (e.g., step 204 and step 308 of FIG. 2).

As previously mentioned, FIGS. 4-6 describe different K cells of a tessellations. For example, FIG. 4 shows an example of a tessellation with a distribution partitioned in 10 cells, FIG. 5 shows an example of a tessellation with a distribution partitioned in 20 cells, and FIG. 6 shows an example of a tessellation with a distribution partitioned in 100 cells. Sampling from the cells or selecting the key data points from the tessellations may ensure that the examples (e.g., selected key data points) that are used to prompt the model, are representative of the entire dataset. Selecting the key data points using the tessellation may also ensure that the evaluation of the model is performed in a way that is representative of the entire dataset, improving the performance of AI techniques and reducing the risk of biases and injected distribution shift (e.g., especially where impact of a mis-performant or non-representative AI models are significant).

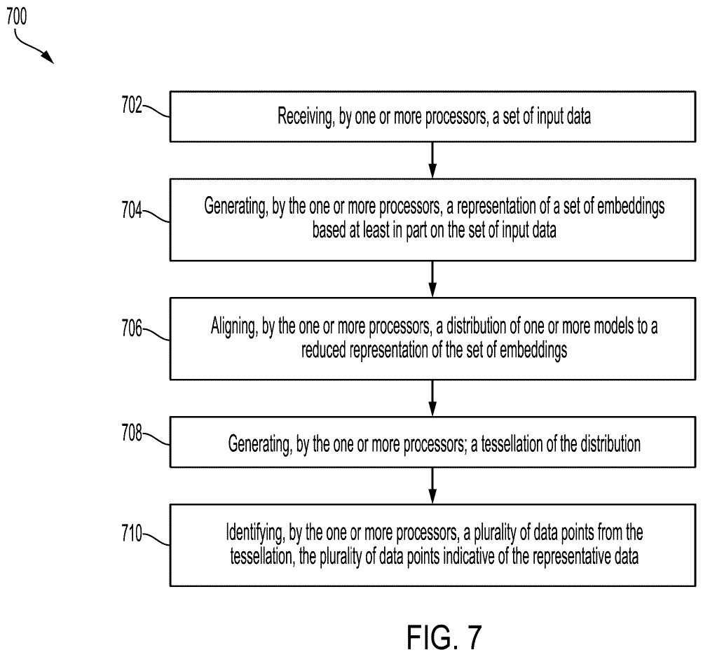

Referring to FIG. 7, a flow diagram for an example method for monitoring a network resource in accordance with aspects of the present disclosure is shown as a method 700. It is noted that the steps or operations described with reference to FIG. 7 are meant to further illustrate aspects of the functionality provided by the one or more modeling engines 120 (e.g., the modeling engine 120 of FIG. 1). Thus, it is to be understood that the functionality described below with reference to the method 700 may be provided by the computing device 110, networks 150, or other types of devices configured to perform the steps of the method 700. The steps or operations of the method 700 may be stored as instructions (e.g., the instructions 116 and/or one or more modeling engines 120) that, when executed by one or more processors (e.g., the one or more processors 112 and/or the one or more modeling engines 120 of FIG. 1), cause the one or more processors to perform the steps of the method 700. It should be understood that the method 700 may be configured to perform various ones of the operations described above with reference to FIGS. 1-6. In the following description of the method 700, the operations performed may be performed in different orders or at different times than the exemplary order shown. Some operations may also be omitted from the method 700, or other operations may be added to the method 700.

At step 702, the method 700 may include receiving, by one or more processors, a set of input data (e.g., N input text). At step 704, the method 700 may include generating, by the one or more processors, a representation of a set of embeddings based on the set of input data. In some examples, generating the representation of embeddings may include applying, by the one or more processors, a set of embedding functions (e.g., relatively expensive independently trained multiple embedding functions or the single and/or relatively less expensive one or more embedding functions) to the set of input data. Generating the representation of embeddings may include applying, by the one or more processors, a dimensionality reduction to the set of embeddings, and generating by the one or more processors, the reduced representation of the set of embeddings based on applying the dimensionality reduction to the set of embeddings.

Additionally, or alternatively, generating the representation of embeddings may include applying, by the one or more processors, a single embedding function (e.g., one embedding function and/or relatively less expensive embedding function(s)) to the set of input data. In such examples, generating the representation of embeddings may include applying, by the one or more processors, a low-rank projection estimation (e.g., low rank projection estimator) to the set of embeddings. In such examples, generating the representation of embeddings may include generating, by the one or more processors, the reduced representation of the set of embeddings based on applying the low-rank projection estimation to the set of embeddings. In such examples, the low-rank projection estimation may be based on a mapping function trained with a sample set of data of the set of input data (e.g., sample of original input texts).

In some examples, a representative set of input data corresponding to the set of data points (e.g., key data points, sample or selected data points) may include less data than the set of input data. The set of input data may include text data.

At step 706, the method 700 may include aligning, by the one or more processors, a distribution of one or more models to a reduced representation of the set of embeddings. At step 708, the method 700 may include generating, by the one or more processors, a tessellation of the distribution. In some examples, the method 700 may further include partitioning, by the one or more processors, the tessellation of the distribution into a set of cells. In such examples, identifying the set of data points may include selecting, by the one or more processors, a centroid data point from each of the set of cells as the set of data point. In some examples, identifying the set of data points may include selecting, by the one or more processors, the set of data points from the set of cells.

Accordingly, at step 710, the method may include identifying, by the one or more processors, a set of data points from the tessellation (e.g., centroid or other points in each of the cells), the set of data points indicative of the representative data. In some examples, the method 700 may include providing, by the one or more processors, the set of data points to one or more language learning models as examples for in-context learning.

Although the embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method, comprising:
receiving, by one or more processors, a set of input data;
generating, by the one or more processors, a representation of a set of embeddings based at least in part on the set of input data;
aligning, by the one or more processors, a distribution of one or more models to a reduced representation of the set of embeddings;
generating, by the one or more processors; a tessellation of the distribution; and
identifying, by the one or more processors, a plurality of data points from the tessellation, the plurality of data points indicative of representative data.

2. The method of claim 1, wherein generating the representation of the set of embeddings further comprises:
applying, by the one or more processors, a plurality of embedding functions to the set of input data;
applying, by the one or more processors, a dimensionality reduction to the set of embeddings; and
generating, by the one or more processors, the reduced representation of the set of embeddings based at least in part on applying the dimensionality reduction to the set of embeddings.

3. The method of claim 1, wherein generating the representation of the set of embeddings further comprises:
applying, by the one or more processors, a single embedding function to the set of input data;
applying, by the one or more processors, a low-rank projection estimation to the set of embeddings; and
generating, by the one or more processors, the reduced representation of the set of embeddings based at least in part on applying the low-rank projection estimation to the set of embeddings.

4. The method of claim 3, wherein the low-rank projection estimation is based at least in part on a mapping function trained with a sample set of data of the set of input data.

5. The method of claim 1, wherein the representative data that is representative of the set of input data corresponds to the plurality of data points, the representative data comprising less data than the set of input data.

6. The method of claim 1, wherein the set of input data comprises text data.

7. The method of claim 1, further comprising:
partitioning, by the one or more processors, the tessellation of the distribution into a plurality of cells.

8. The method of claim 7, wherein identifying the plurality of data points comprises:
selecting, by the one or more processors, a centroid data point from each of the plurality of cells as the plurality of data points.

9. The method of claim 7, wherein identifying the plurality of data points comprises:
selecting, by the one or more processors, the plurality of data points from the plurality of cells.

10. The method of claim 1, further comprising:
providing, by the one or more processors, the plurality of data points to one or more language learning models as examples for in-context learning.

11. An apparatus, comprising:
one or more memories storing processor-executable code; and
one or more processors coupled with the one or more memories and individually or collectively operable to execute the code to cause the apparatus to:
receive a set of input data;
generate a representation of a set of embeddings based at least in part on the set of input data;
align a distribution of one or more models to a reduced representation of the set of embeddings;
generate a tessellation of the distribution; and
identify a plurality of data points from the tessellation, the plurality of data points indicative of representative data.

12. The apparatus of claim 11, wherein, to generate the representation of the set of embeddings, the one or more processors are individually or collectively further operable to execute the code to cause the apparatus to:
apply a plurality of embedding functions to the set of input data;
apply a dimensionality reduction to the set of embeddings; and
generate the reduced representation of the set of embeddings based at least in part on applying the dimensionality reduction to the set of embeddings.

13. The apparatus of claim 11, wherein, to generate the representation of the set of embeddings, the one or more processors are individually or collectively further operable to execute the code to cause the apparatus to:
apply a single embedding function to the set of input data;
apply a low-rank projection estimation to the set of embeddings; and
generate the reduced representation of the set of embeddings based at least in part on applying the low-rank projection estimation to the set of embeddings.

14. The apparatus of claim 13, wherein the low-rank projection estimation is based at least in part on a mapping function trained with a sample set of data of the set of input data.

15. The apparatus of claim 11, wherein the representative data that is representative of the set of input data corresponds to the plurality of data points, the representative data comprising less data than the set of input data.

16. The apparatus of claim 11, wherein the set of input data comprises text data.

17. The apparatus of claim 11, wherein the one or more processors are individually or collectively further operable to execute the code to cause the apparatus to partition the tessellation of the distribution into a plurality of cells.

18. The apparatus of claim 17, wherein, to identify the plurality of data points comprises, the one or more processors are individually or collectively further operable to execute the code to cause the apparatus to:
select a centroid data point from each of the plurality of cells as the plurality of data points.

19. The apparatus of claim 18, wherein, to identify the plurality of data points comprises, the one or more processors are individually or collectively further operable to execute the code to cause the apparatus to:
select the plurality of data points from the plurality of cells.

20. A non-transitory computer-readable medium storing code for wireless communication, the code comprising instructions executable by one or more processors to:
receive a set of input data;
generate a representation of a set of embeddings based at least in part on the set of input data;
align a distribution of one or more models to a reduced representation of the set of embeddings;
generate a tessellation of the distribution; and
identify a plurality of data points from the tessellation, the plurality of data points indicative of representative data.
